(19) United States
(12) Patent Application Publication
(10) Pub. No.: US 2010/0038895 A1
(43) Pub. Date: Feb. 18, 2010

(54) FILE WITH POSITIONABLE LABEL

(75) Inventor: Lauren Grassia, East Northport, NY (US)

Correspondence Address: DORSEY & WHITNEY LLP;INTELLECTUAL PROPERTY DEPARTMENT, 250 PARK AVENUE, NEW YORK, NY, 10177, US

(73) Assignee: ESSELTE CORPORATION, Melville, NY (US)

(21) Appl. No.: 12/538,101

(22) Filed: Aug. 7, 2009

Related U.S. Application Data
(60) Provisional application No. 61/087,505, filed on Aug. 8, 2008.

(51) Int. Cl. B42F 7/00

(52) U.S. Cl. 281/45

(57) ABSTRACT

In accordance with one embodiment, a file system is provided comprising a file, a closure band, and a positionable label. The closure band is fixable, removably or permanently, to the file. The label is coupled to the closure band and is positionable such that it can be moved along the closure band for positioning at different locations on the file.

### CROSS REFERENCE TO RELATED APPLICATION

The present application claims priority from U.S. Provisional Patent Application No. 61/087,505 filed Aug. 8, 2008, the disclosure of which is incorporated herein by reference in its entirety.

### FIELD OF THE INVENTION

The present invention relates to a file system comprising a file with a positionable label. More particularly, the present invention relates to a file system comprising a file with a closure band and a positionable label mounted to the closure band.

### BACKGROUND OF THE INVENTION

Files have become ubiquitous as means for storing and organizing documents or other materials. Files are available in many sizes and configurations. These folders are often stacked, for example, on a desk surface, or positioned side-by-side, for example in a book case or similar structure. A challenge that exists, particularly when multiple files are positioned on top of or adjacent one another, is identifying the content of the file. While the files can include portions thereon for writing identifying information, these portions can be obscured and access to the identifying information only possible upon moving the files. Further, even if labels are provided, the labels often are only provided in a single position on the file and thus only viewable when the file is oriented in a particular manner.

U.S. Pat. No. 1,463,827 discloses a file and a wrapper band. The wrapper band is formed by a strip adapted to extend across the back of the file and to overlap its two covers, and a tape or string passing round the and its ends secured together. The portion of the strip passing over the back of the file is provided with spaces to enter thereon the particulars of the documents placed in the file and other reference matters. The wrapper is formed with its strip portion attached permanently to the bottom cover of the file.

There is a need for a file system including files having identifying labels that are positionable as desired to facilitate access to identifying information on the labels.

### SUMMARY OF THE INVENTION

A file system comprising a file with a closure band and a positionable label mounted to the closure band is provided.

In accordance with one embodiment, a file system is provided comprising a file, a closure band, an attachment member, and a positionable label. The closure band is positionable in a closing position around the file for maintaining the file in a closed position, and movable to a released position for releasing the file from the closed condition. The attachment member is configured for mounting the closure band to a portion of the file in both the closed and released positions. The positionable label is mounted to the closure band, such that the label is movable along the closure band for selective repositioning at different locations on the file with the closure band positioned around the file. The closure band can be permanently fixed to the file.

In some embodiments, the file is an expandable file. Further, the file can include an overlapping top portion that is pivotable to a position to close the file, the closure band being disposed around the top portion when positioned around the file. The closure band can be secured to the overlapping top portion. Alternatively, the file can have an open top.

The closure band is fixed to the file in the preferred embodiment, such that it can be selectively positioned around the file in a generally horizontal orientation or in a generally vertical orientation. The closure band can be secured to the file by the attachment member.

The attachment member can include anchor elements on the closure band and the file includes openings for receiving the anchor elements for securing the band to the file. The file can have a plurality of openings such that the closure band can be secured to the file at a plurality of locations.

The closure band is preferably elastic, and preferably has a width and the label has a width. In some embodiments the width of the label is substantially larger than the width of the closure band, while in some embodiments the width of the label is approximately the same as the width of the closure band, and in other embodiments the width of the label is less than the width of the closure band.

The label can include a support structure and a label structure. The label structure can be insertable into the support structure. The support structure can have a window providing visual access to the label structure. The label can be three-dimensional. Preferably, the label is sufficiently flexible for permitting the label to bend around different sides of the file. The label can be replaceable on the closure band.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 illustrates a file system, in accordance with one embodiment.

FIG. 2a illustrates a perspective view of an open expandable file for use with file systems as disclosed herein, in accordance with one embodiment.

FIG. 2b illustrates a perspective view of a first envelope expandable file for use with file systems as disclosed herein, in accordance with one embodiment.

FIG. 2c illustrates a perspective view of a second envelope expandable file for use with file systems as disclosed herein, in accordance with one embodiment.

FIG. 2d illustrates a perspective view of a hanging file for use with file systems as disclosed herein, in accordance with one embodiment.

FIG. 2e illustrates a front view of a tri-fold file for use with file systems as disclosed herein, the tri-fold file being in an open configuration, in accordance with one embodiment.

FIG. 2f illustrates a front view of a tri-fold file for use with file systems as disclosed herein, the tri-fold file being in a closed configuration, in accordance with one embodiment.

FIG. 2g illustrates a side view of an expandable file for use with file system as disclosed herein, in accordance with one embodiment.

FIG. 2h illustrates a top view of a file for use with file systems as disclosed herein, the file having three pockets, in accordance with one embodiment.

FIG. 3a illustrates a perspective view of a cord closure band for use with file systems as disclosed herein, in accordance with one embodiment.

FIG. 3b illustrates a perspective view of a ribbon closure band for use with file systems as disclosed herein, in accordance with one embodiment.

FIG. 3c illustrates a perspective view of a band closure band for use with file systems as disclosed herein, in accordance with one embodiment.

FIG. 3d illustrates a front view of a band closure band for use with file systems as disclosed herein, the band including tracks, in accordance with one embodiment.

FIG. 3e illustrates a front view of a closure band and file with the closure band oriented substantially vertically, in accordance with one embodiment.

FIG. 3f illustrates a front view of closure band and file with the closure band oriented substantially horizontally, in accordance with one embodiment.

FIG. 4a illustrates a perspective view of a closure band suitable for use with file system as disclosed herein, the closure band including fastening elements at first and second ends thereof, in accordance with one embodiment.

FIG. 4b illustrates a front view of a file with the closure band of FIG. 4a fastened thereto and with the fastening elements of the closure band extending through bores of a file, in accordance with one embodiment.

FIG. 4c illustrates a front view of a file suitable for use with file systems as disclosed herein, the file including a plurality of bores for receiving fastening elements, in accordance with one embodiment.

FIG. 4d illustrates a front view of a file with a closure band threaded through bores thereof, in accordance with one embodiment.

FIG. 5a illustrates a front view of a generally flat rectangular label, in accordance with one embodiment.

FIG. 5b illustrates a perspective view of a generally cylindrical label, in accordance with one embodiment.

FIG. 5c illustrates a perspective view of a generally triangular 3-D label, in accordance with one embodiment.

FIG. 6a illustrates a perspective view of a plurality of files positioned with the labels oriented on a side of the files, in accordance with one embodiment.

FIG. 6b illustrates a top view of a plurality of files positioned with the labels oriented on a top of the files, in accordance with one embodiment.

FIG. 6c illustrates a front view of file with the label oriented at a front portion of the file, in accordance with one embodiment.

FIG. 7a illustrates a perspective view of a cord closure band and a label sized substantially larger than the diameter of the cord, in accordance with one embodiment.

FIG. 7b illustrates a perspective view of a ribbon closure band and a label sized such that one dimension of the label is substantially the same as the width of the ribbon, in accordance with one embodiment.

FIG. 7c illustrates a front view of a band closure band having tracks wherein the label is provided within the tracks and is sized such that one dimension of the label is smaller than the width of the band, in accordance with one embodiment.

FIG. 7d illustrates a perspective view of a cord closure band with a generally 3-D triangular label, in accordance with one embodiment.

FIG. 7e illustrates a perspective view of a cord closure band with a generally cylindrical label, in accordance with one embodiment.

FIG. 8a illustrates a perspective view of an open expandable file with horizontally extending cord closure band and generally rectangular label, in accordance with one embodiment.

FIG. 8b illustrates a perspective view of an envelope expandable file with a generally ribbon closure band and generally circular label, in accordance with one embodiment.

FIG. 8c illustrates a perspective view of an envelope expandable file with a generally ribbon closure band and a generally 3-D triangular label, in accordance with one embodiment.

FIG. 8d illustrates a perspective view of a hanging file with a closure band and a generally rectangular label, in accordance with one embodiment.

FIG. 8e illustrates a front view of a tri-fold file with elastic closure band and a cylindrical label, the tri-fold file being in an open configuration, in accordance with one embodiment.

FIG. 8f illustrates a front view of a tri-fold file with elastic closure band and a cylindrical label, the tri-fold file being in a closed configuration, in accordance with one embodiment.

### DETAILED DESCRIPTION OF EXEMPLARY EMBODIMENTS

A file system comprising a file with a positionable label is provided. More particularly, a file system comprising a file with a closure band positionable in a closing position around the file, an attachment member for mounting the closure band to the file, and a positionable label mounted to closure band is provided.

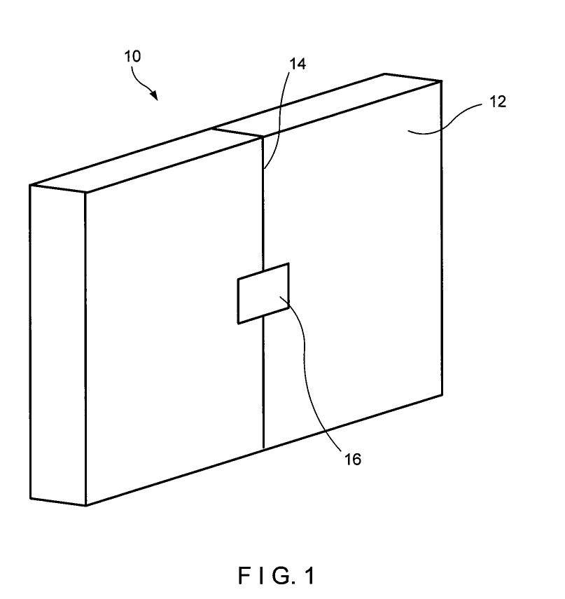

In various embodiments, and as shown in FIG. 1 in accordance with an exemplary embodiment, a file system 10 comprising a file 12, closure band 14, and label 16, is provided. Generally, the closure band 14 is positionable in a closing relationship around the file 12 for maintaining the file in a closed position and is movable to a released position releasing the file from the closed position. The label 16 is mounted to the closure band 14 such that it is movable along the closure band for selective repositioning at different locations on the file with the closure band positioned around the file. Such repositioning can be used to facilitate viewing of the label in various orientations on the file 12. Thus, organization of files is not dependent on orienting the files in a particular manner to view the label. Preferably, the files of the preferred embodiment are configured to contain a plurality of sheets of office paper, such as letter, legal, A4 sized or greater. Expandable file embodiments preferably are dimensioned to hold stacks of hundreds of preferably unfolded sheets.

File

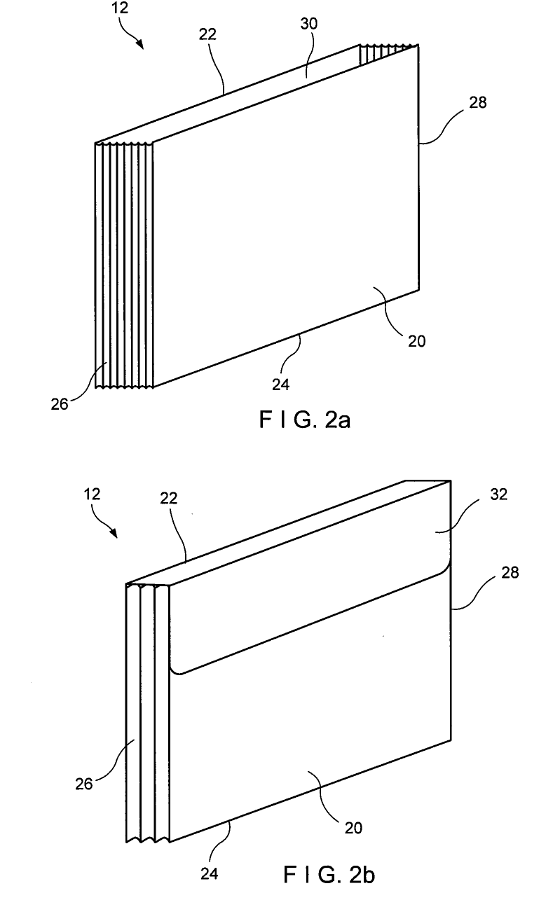

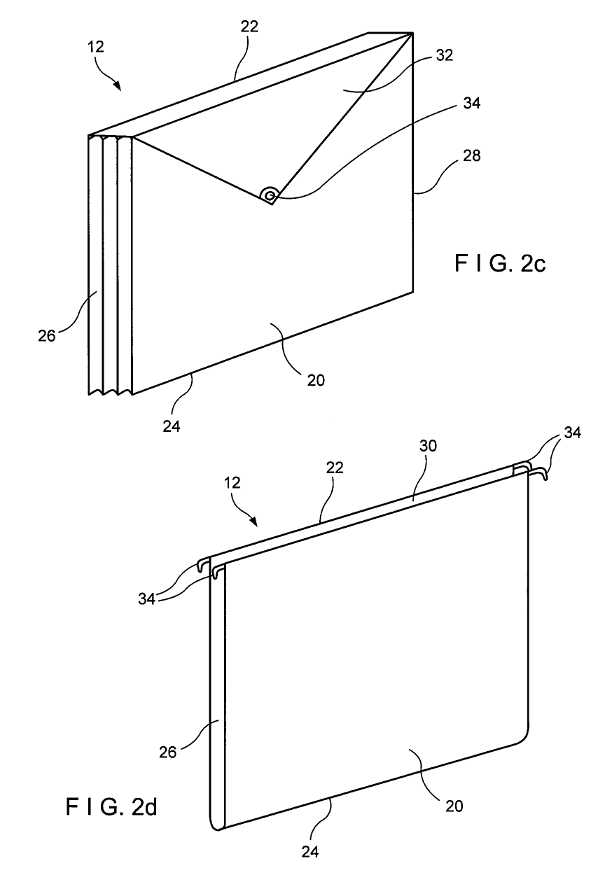

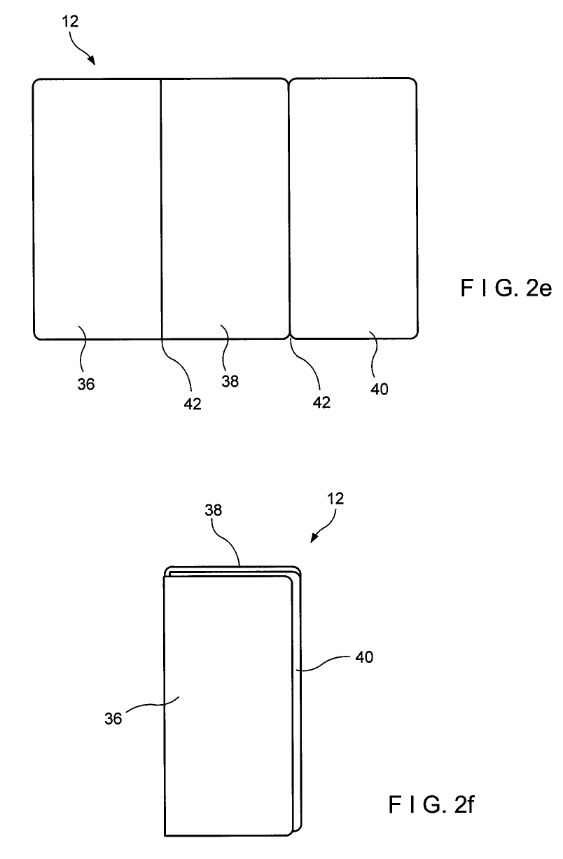

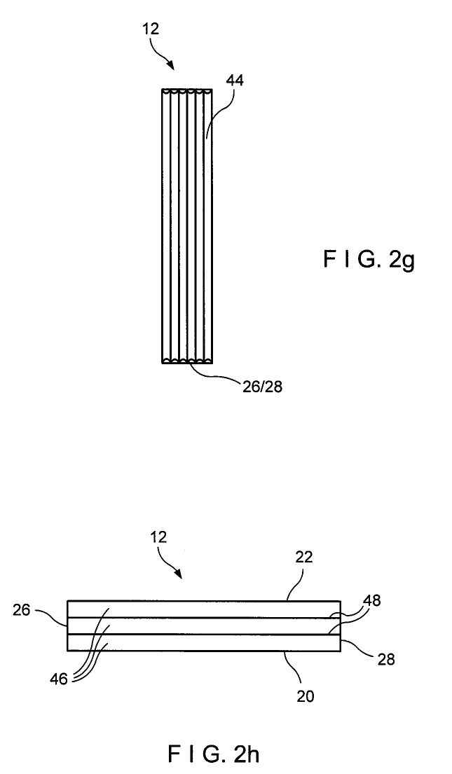

The file can be one of any suitable variety as known in the art. FIGS. 2a-2h illustrate various file configurations. FIG. 2a illustrates an expandable file 12 having front and back portions 20, 22, a bottom end 24, two side ends 26, 28, and an open top end 30. FIGS. 2b and 2c illustrate embodiments of an expandable file 12 having a generally envelope configuration and having front and back portions 20, 22, a bottom end 24, two side ends 26, 28, and overlapping top portion 32. In the embodiment of FIG. 2b, the overlapping top portion 32 is generally rectangular. In the embodiment of FIG. 2c, the overlapping top portion 32 is generally triangular. Regardless of configuration of overlapping top portion 32, the overlapping top portion 32 is pivotable from an open position to a closed position closing the file, the closed position being shown in FIGS. 2b and 2c. A locking feature 34 can be provided on the overlapping top portion 32 for fixing the overlapping top portion 32 in a closed position. FIG. 2d illustrates a hanging file 12. As shown, the hanging file 12 has front and back portions 20, 22, a closed bottom end 24, two open side ends 26, 28, and an open top end 30. Hanging elements 34 are provided at ends of the open top end 30. FIGS. 2e and 2f illustrates a tri-fold file 12 having a first side portion 36, a middle portion 38, and a second side portion 40. In the embodiment shown, the first side portion 36, middle portion 38, and second side portion 40 are generally integral to one another and separated by folds 42. FIG. 2e illustrates the tri-fold file 12 in an open configuration and FIG. 2f illustrates the tri-fold file 12 in a closed configuration. FIG. 2g illustrates a side view of an expandable file 12, such as can be present in any of the expandable embodiments described. As shown, the file 12 comprises a series of folds 44. The side 26/28, including series of folds, can be referred to as a gusset and can be arranged to provide an expandable accordion file.

As may be appreciation, various features can be provided with any of the disclosed, or other suitable, files. For example, one or more ends portions of the files can be reinforced, such as with reinforced gussets at points of wear or along a seam of a folding portion. For example, closed bottom ends can be reinforced. Further, the file can have a single pocket or can have a plurality of pockets. FIG. 2h illustrates a top view of a file having a front portion 20, a back portion 22, first and second sides 26, 28, and pockets 46. While in the embodiment shown, three pockets 46 are provided, more or fewer pockets 46 can be provided. The file further includes dividers 48 between the pockets 46. The dividers 48 can be substantially similar to front and back portions 20, 22 of the file 12 or can be, for example, more or less durable than the front or back portions 20, 22 of the file 12. In embodiments including a locking feature, the locking feature can be a magnet, can be hook-and-eye (e.g., Velcro), can be a slide lock, or other lock configuration as known to those skilled in the art. One or more portions of the file can be colored, for example for organizational purposes. For example, in one embodiment, the gussets or the overlapping top portion can be colored.

The file can be formed of any suitable material. For example, the file can be formed of a fiber, a polymer (such as polypropylene), post-consumer material, kraft material, manila, or pressboard. The material of the file can be coated or otherwise treated to provide durability, moisture resistance, or other.

Closure Band

The file with positionable label includes a closure band. Generally, the closure band can be formed as an elongate material positionable in a closing position around the file for maintaining the file in a closed condition and movable to a released position releasing the file from the closed condition. An attachment member can be provided configured for mounting the closure band to a portion of the file in both the closed and released positions The closure band can be mounted to the file prior to distribution to consumers or can be mounted to the file by consumers, as described. In some embodiments, the closure band functions as, and in lieu of, a locking feature.

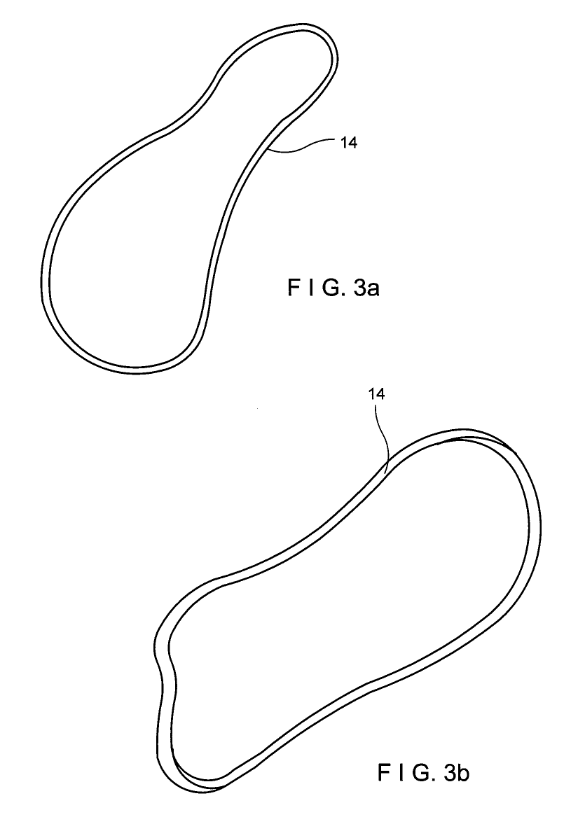

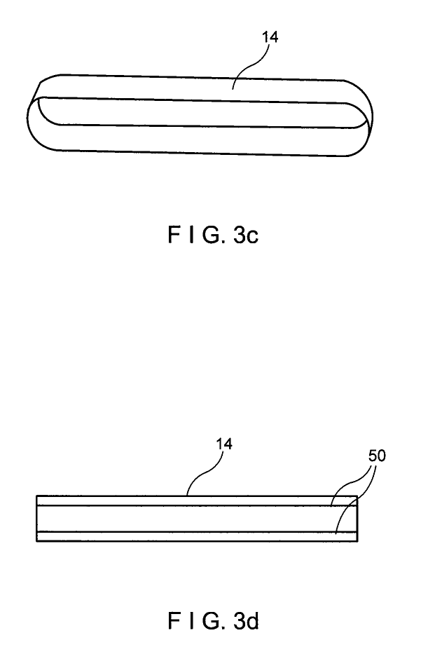

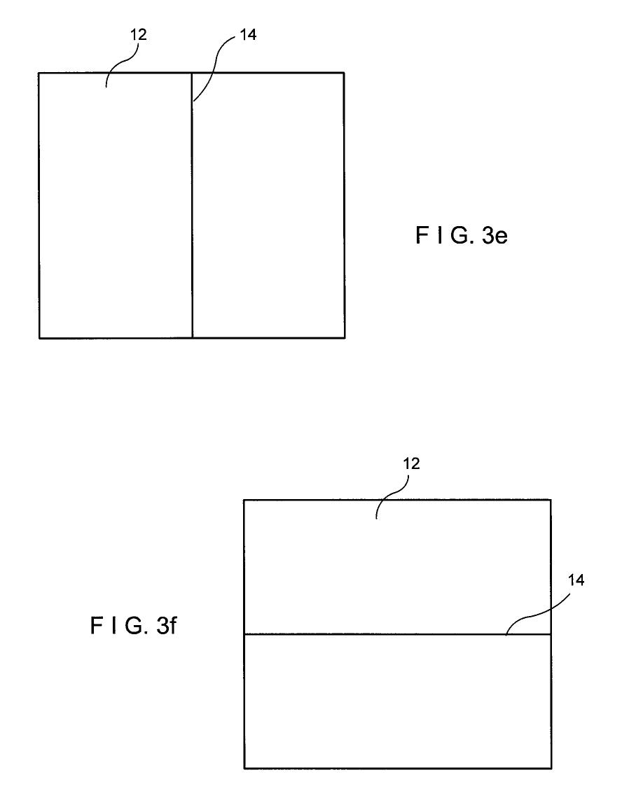

The closure band can have any suitable configuration and can be elastic or non-elastic. While some dimensions are given to illustrate suitable sizes for the closure bands, it is to be appreciated that these sizes are intended for illustrative purposes only. FIG. 3a illustrates a cord closure band 14. The cord can be a fiber, can be a twine, can be twisted, can be braided, or can otherwise be configured. FIG. 3b illustrates a ribbon closure band 14. The ribbon can have, for example, an approximately 0.5 inch width. FIG. 3c illustrates a band closure band 14. The band can have, for example, an approximately 1 inch width. FIG. 3d illustrates a band closure band 14 including tracks 50 for receiving a label. The closure band 14 can be formed of any suitable material. For example, the closure band can be formed of elastic, cotton or other fibers, polymer, or other material.

As fastened to the file 12, the closure band 14 can be oriented substantially vertically, as shown in FIG. 3e, or substantially horizontally, as shown in FIG. 3f.

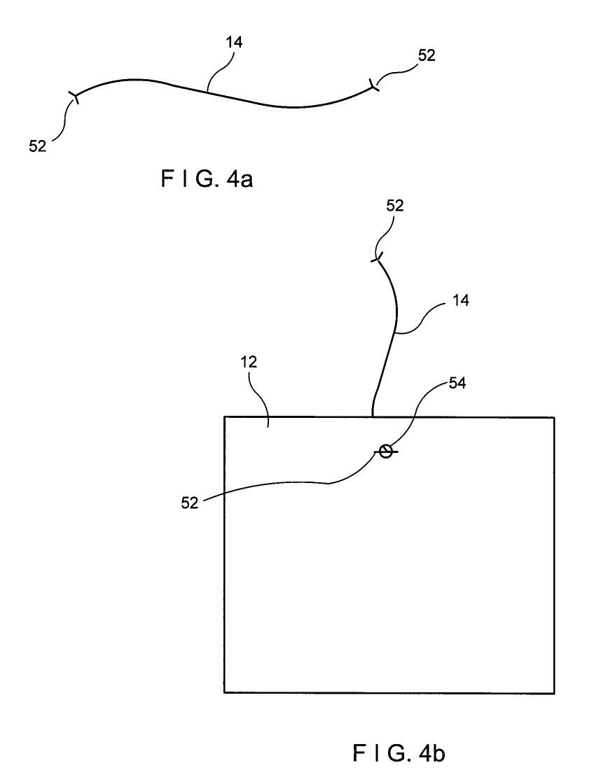

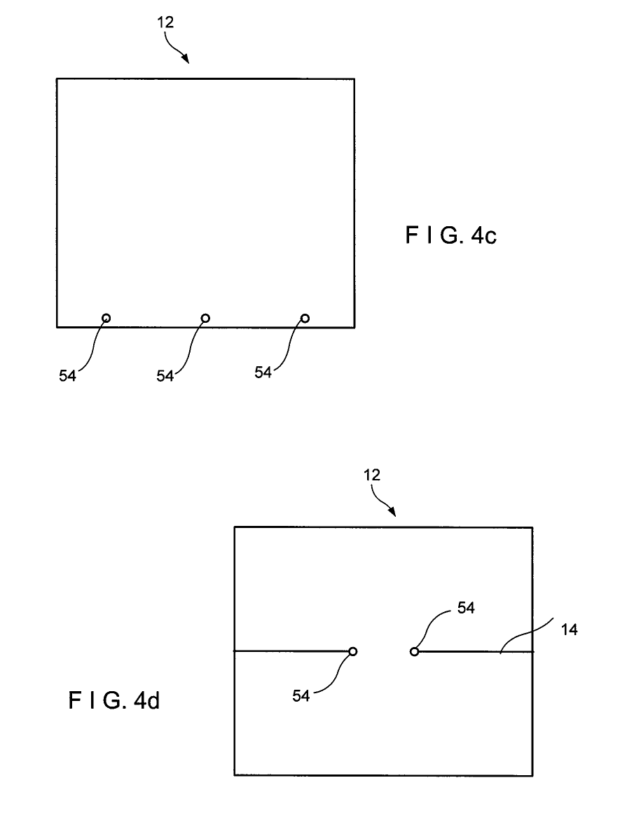

The closure band 14 can be fixed to the file 12 in any suitable manner. FIG. 4a illustrates a closure band including fastening elements 52 at first and second ends thereof. The fastening elements 52 act as an attachment member for mounting the closure band to the file. The fastening elements 52 are intended for insertion through an opening defined in the file such that, after insertion, the fastening element 52 achieves a configuration perpendicular to the closure band 14 and is retained within the file. FIG. 4b illustrates a file 12 having an opening 54 with the closure band 14 of the fastening element 52 positioned therethrough. In some embodiments, a file 12 can be provided with a plurality of openings 54 for receiving the fastening element such that a consumer can choose where to fix the closure band to the file. FIG. 4c illustrates a file 12 with three openings 54 for receipt of fastening elements. As shown, the openings 54 are provided at different locations on the file 12 to permit consumer choice of closure band placement. It is to be appreciated that while FIG. 4c illustrates a single portion of the file 12, corollary bores are provided on the reverse portion of the file 12. For receiving the fastening elements, the bores can be provided at various horizontal positions, at various vertical positions, or at both various horizontal and various vertical positions. In some embodiments, the openings 54 can be reinforced, for example with a grommet or rivet.

In alternative embodiments, the closure band can be stapled or adhered to the file. In these embodiments, the staple or adhesive thus form the attachment member for mounting the closure bad to the file. Such stapling or adhesion can be at a bottom portion of the file, at an overlapped top portion of the file, or at other suitable location on the file. In some embodiments, the closure band 14 can be threaded through bores 54 in the file 12, as shown in FIG. 4d.

Generally, while the closure band can be permanently mounted or can be removably mounted to the file, the closure band, once mounted, is fastened securely to the file.

Label

A positionable label is provided mounted with the closure band such that the label is movable along the closure band for selective repositioning at different locations on the file with the closure band positioned around the file. In some embodiments, the label includes a support structure and a printable structure. The support structure provides the support and configuration of the label while the printable structure provides an organizational portion of the label. The organizational portion of the label can be customizable. The support structure and printable structure can be the same structure, and the printable structure can be inserted into the support structure. In some embodiments, the support structure has a window for providing viewing access to the printable structure. In some embodiments, the printable structure can be fastened or adhered to an exterior of the support structure. The support structure can be substantially rigid or can be flexible. Flexible support structures can be oriented on the file such that the bend across portions of the file, for example, bending from a top portion to a front portion. In some embodiments, the label, or the support structure of the label, can be provided with gripping portions to facilitate user handling and manipulation of the label. In use, the label can be moved along the closure band to any suitable position on the file by user manipulation of the label. For example, the label can slide along the closure band. In some embodiments, the label can be releasably mounted to the closure band such that, the label can be replaced when the label becomes worn or when a new label is desired. For example, in embodiments, wherein the support structure comprises the label structure, if new information is desired on the label structure, the label can be replaced.

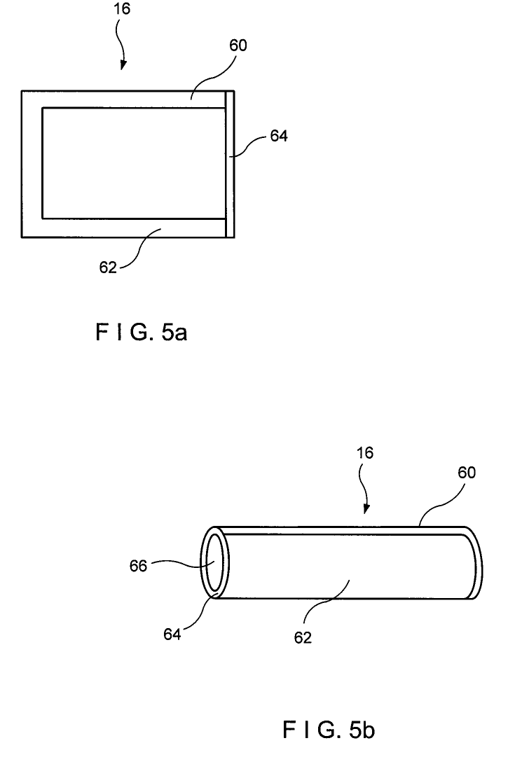

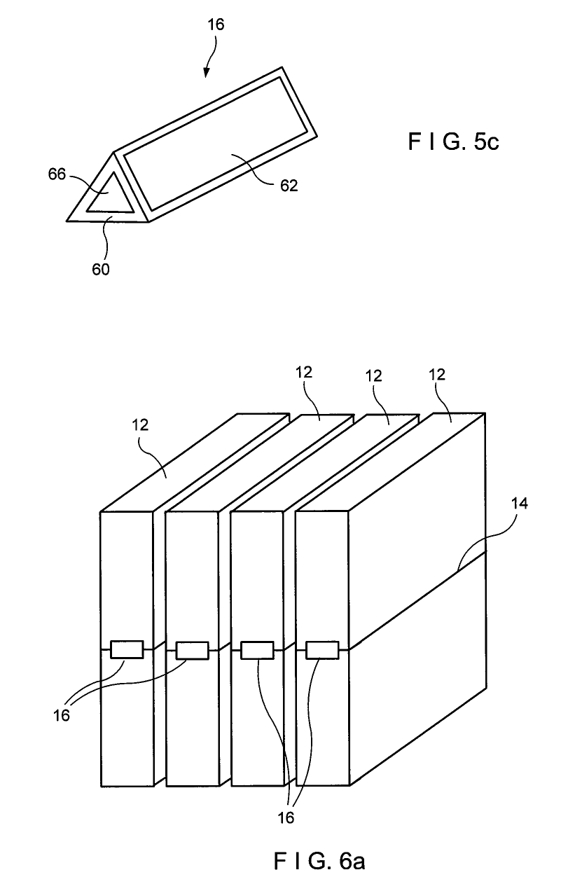

Any suitable configuration of label can be used. As discussed above, the support structure can provide the configuration for the label. Description is made both of possible 3-D shapes and of possible 2-D shapes. FIG. 5a illustrates a generally flat rectangular label 16 comprising a support structure 60 and a label structure 62. As shown, the support structure 60 has a slot 64 through which the label structure 62 can be inserted. The support structure 60 is further provided with a coupling element for coupling with the closure band. The coupling element can be a hook-and-eye (or Velcro) piece, a ribbon with a snap, a bore for receiving the closure band, or other. FIG. 5b illustrates a generally cylindrical label 16 comprising a support structure 60 and a label structure 62. As shown, the support structure 60 has a slot 64 through which the label structure 62 can be inserted. In the embodiment of FIG. 5b, the coupling element is a bore 66. FIG. 5c illustrates a generally triangular 3-D label comprising a support structure 60 and a label structure 62. In this embodiment, the label structure is adhered to a surface of the support structure 60. A plurality of label structures 62 can be used, for example one label structure for each surface of the triangular support structure 60. In accordance with various embodiments, the label can be generally circular, generally rectangular, generally oval, or other.

As noted, the printable structure of the label provides organizational characteristics. The printable structure thus can be suitable for writing thereon. In other embodiments, the printable structure can have pre-printed material. In yet other embodiments, the printable structure can be color coded.

System

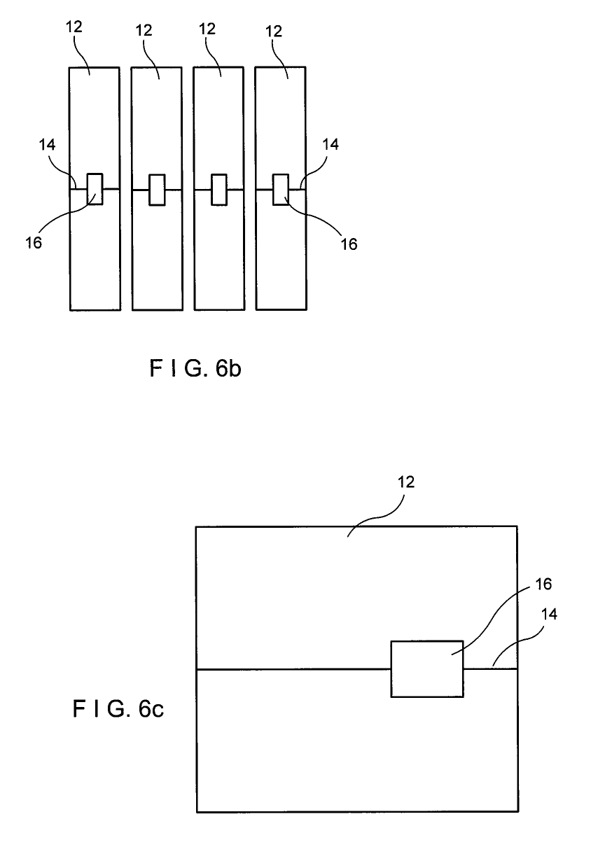

The file, closure band, and positionable label together form a file system with enhanced organizational features. The positionable label can be oriented in any manner suitable for viewing the information provided thereupon. While various orientations of closure bands and positions of labels are shown, these are intended to be illustrative only. FIG. 6a illustrates a plurality of files 12 positioned with the labels 16 oriented on a side end of the files 12. As shown, the closure bands 14 are oriented generally horizontally FIG. 6b illustrates a plurality of files 12 positioned with the labels 16 oriented on a top end of the files 12. As may be appreciated, the closure bands 14 are oriented generally vertically. FIG. 6c illustrates a file 12 with the label 16 oriented at a front portion of the file 12 and with the closure band 14 oriented generally horizontally. In some embodiments, the closure band 14 can be fixed to the file in a manner such that the closure band 14 can be selectively positioned around the file in a horizontal orientation or a vertical orientation.

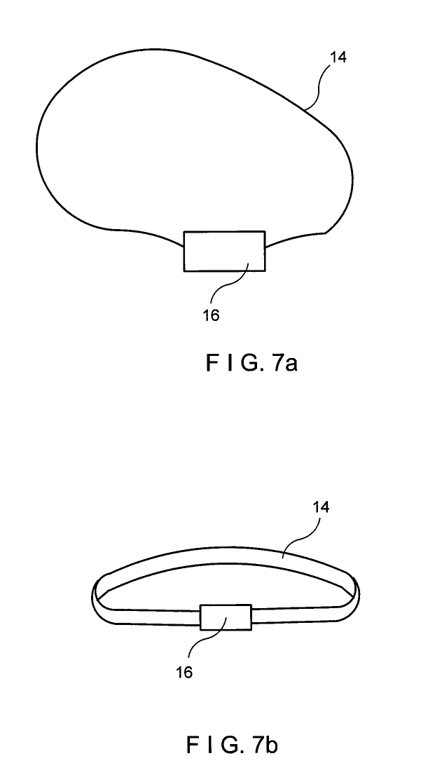

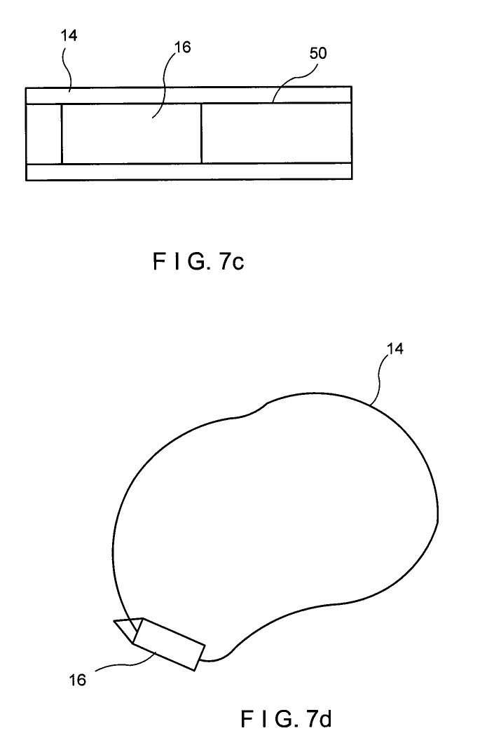

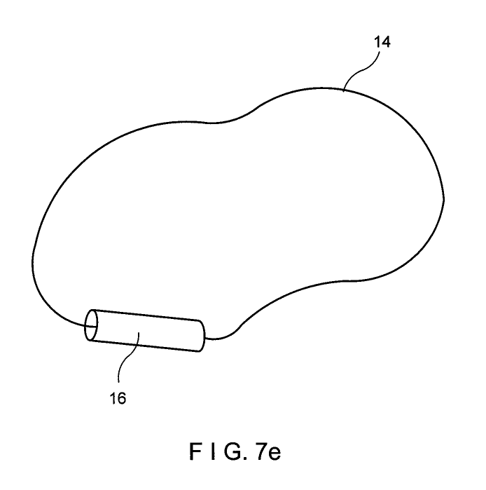

In use, the closure band is fastened to the file and the label is coupled to the closure band. The label is mounted in a manner such that its position and/or orientation can be adjusted. Thus, for example, the label can be slidable over the closure band. The relative size and configuration of the closure band and label can vary. Reference is made to a width of the closure band and a width of the label. The width of the closure band can refer to a dimension of the closure band other than the length of the closure band. The width of the label can refer to the dimension of the label extending along the width of the closure band. FIG. 7a illustrates a cord closure band 14 and a label 16 wherein the width of the label is substantially larger than the width (or diameter) of the cord. FIG. 7b illustrates a ribbon closure band 14 and a label 16 sized such that the width of the label 16 is substantially the same as the width of the ribbon. FIG. 7c illustrates a band closure band 14 having tracks 50 wherein the label 16 is provided within the tracks 50 and is sized such that the width of the label 16 is smaller than the width of the band. FIG. 7d illustrates a cord closure band 14 with a generally 3-D triangular label 16. As may be appreciated, the triangular label 16 can be rotated such that a particular surface is oriented outwardly. FIG. 7e illustrates a cord closure band 14 with a generally cylindrical label 16.

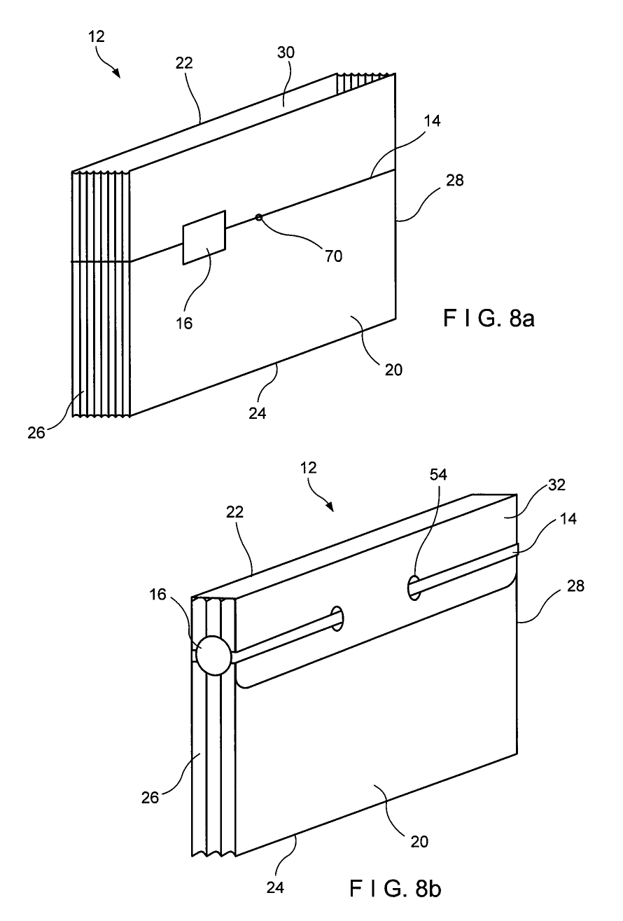

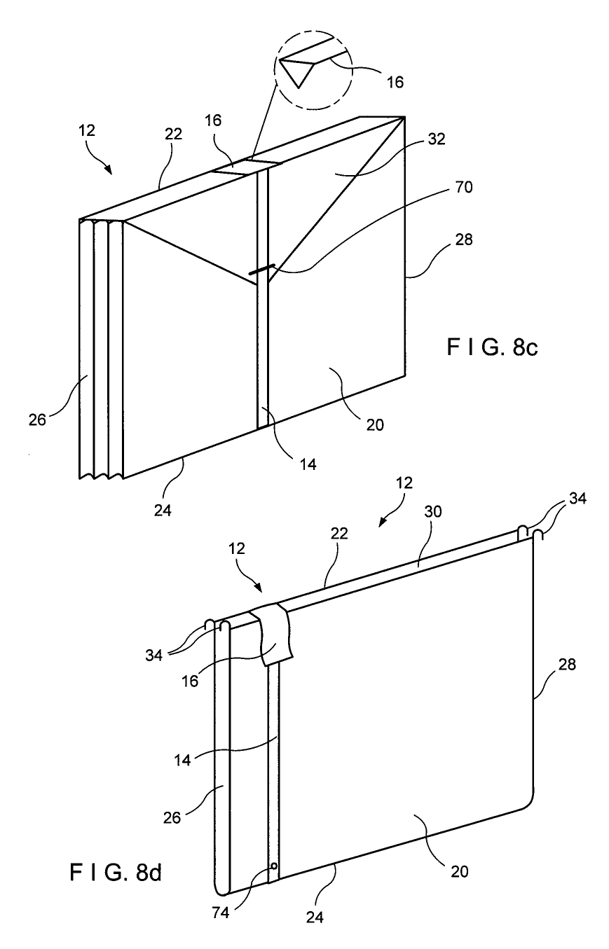

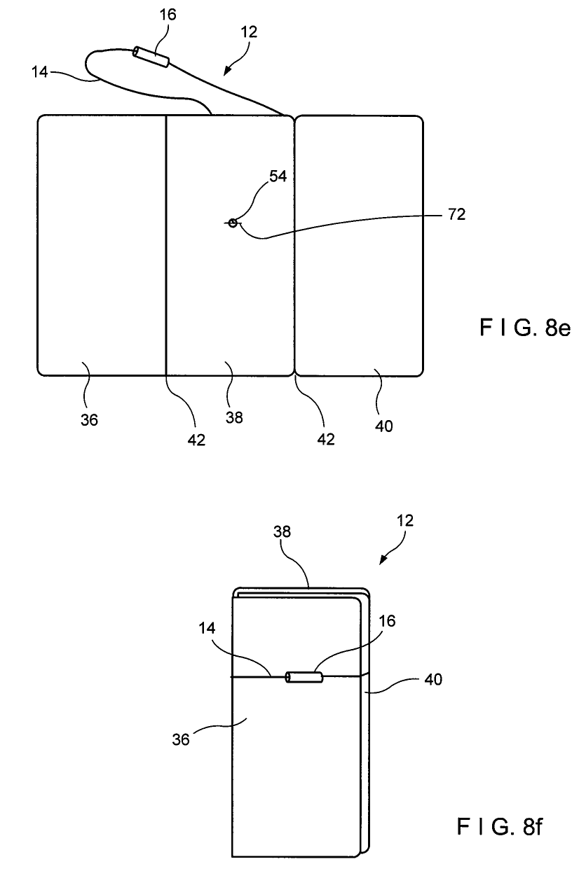

FIGS. 8a-8f illustrate various files with closure bands and repositionable labels. The file configurations correlate generally to the files shown in FIGS. 2a-2f. It is to be understood that the various combinations and orientations of elements are for illustrative purposes only and are not intended to be limiting.

FIG. 8a illustrates an expandable file having front and back portions 20, 22, a bottom end 24, two side ends 26, 28, and an open top end 30. A horizontally extending cord closure band 14 is provided with a generally rectangular repositionable label 16. As shown, the label 16 is positioned towards a side of the front portion 20. This position, however, can be changed by moving the label 16 along the cord closure band 14. The cord closure band 14 is fastened with a attachment member 70 generally centrally on the front portion 20 of the file 12. As shown, the orientation of the closure band 14 can be maneuvered to a vertical orientation.

FIGS. 8b and 8c illustrate embodiments of an expandable file having a generally envelope configuration and having front and back portions 20, 22, a bottom end 24, two side ends 26, 28, and overlapping top portion 32. In the embodiment of FIG. 8b, the overlapping top portion 32 is generally rectangular. A generally ribbon closure band is provided fastened to the file 12 via threading through openings 54 on the overlapping top portion 32. The openings 54 thus form the attachment member. A generally circular label 16 is mounted to the ribbon closure band 14. As shown, the label 16 is positioned on a side end 26 of the file 12. This position, however, can be changed by moving the label 16 along the ribbon closure band 14. In the embodiment of FIG. 8c, the overlapping top portion 32 is generally triangular. A horizontally extending generally ribbon closure band is provided fastened generally centrally on the overlapping top portion. A generally 3-D triangular label 16 is coupled to the ribbon closure band 14. As shown, the label 16 is positioned on the top portion. This position, however, can be changed by moving the label 16 along the closure band 14. Regardless of configuration of the overlapping top portion 32, the overlapping top portion 32 can be manipulated from an open position to a closed position, shown in FIGS. 8b and 8c. A locking feature can be provided on the overlapping top portion 32 for fixing the overlapping top portion 32 in a closed position.

FIG. 8d illustrates a hanging file 12. As shown, the hanging file 12 has front and back portions 20, 22, a closed bottom end 24, two open side ends 26, 28, and an open top end 30. Hanging elements 34 are provided at ends of the open top end 30. A vertically extending closure band 14 is provided fastened using a rivet 74. A generally rectangular label is mounted on the closure band 14. FIG. 8d illustrates the label 16 positioned on a front portion and extending over the open top end 30 of the hanging file 12. The position of the label 16 can be changed by moving the label 16 along the closure band 14.

FIGS. 8e and 8f illustrates a tri-fold file 12r having a first side portion 36, a middle portion 38, and a second side portion 40. In the embodiment shown, the first side portion 36, middle portion 38, and second side portion 40 are generally integral to one another and separated by folds 42. An elastic closure band 14 is provided fastened generally centrally on a back side of the middle portion. Fastening can be achieved, for example, via extending ends of the closure band through an opening 54 in the file 12 and forming a knot 72 to prevent slippage of the ends back through the opening 54. The knot 72 and opening 54 thus form an attachment member. A generally cylindrical label 16 is mounted to the closure band 14. As shown, the label 16 is positioned on the first side portion 36 when the file 12 is folded. FIG. 8e illustrates the tri-fold file 12 in an open configuration with the closure band coupled thereto but not positioned therearound and FIG. 8f illustrates the tri-fold file in a closed configuration with the closure band provided around the file.

As used in this application, the term “about” should generally be understood to refer to both the corresponding number and a range of numbers. Moreover, all numerical ranges herein should be understood to include each whole integer within the range.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A file system comprising:
a file;
a closure band positionable in a closing position around the file for maintaining the file in a closed condition, and movable to a released position releasing the file from the closed condition;
an attachment member configured for mounting the closure band to a portion of the file in both the closed and released positions; and
a positionable label mounted to the closure band, such that label is movable along the closure band for selective repositioning at different locations on the file with the closure band positioned around the file.

2. The file system of claim 1, wherein the file is an expandable file.

3. The file system of claim 2, wherein the file includes an overlapping top portion that is pivotable to a position to close the file, the closure band being disposed around the top portion when positioned around the file.

4. The file system of claim 3, wherein the closure band is secured to the overlapping top portion.

5. The file system of claim 1, wherein the closure band is fixed to the file such that it can be selectively positioned around the file in a generally horizontal orientation or a generally vertical orientation.

6. The file system of claim 1, wherein the attachment member includes anchor elements on the closure band, and openings defined in the file for receiving the anchor elements for securing the band to the file.

7. The file system of claim 6, wherein the file includes a plurality of openings such that the closure band can be secured to the file at plurality of locations.

8. The file system of claim 1, wherein the closure band is permanently fixed to the file.

9. The file system of claim 1, wherein the closure band is elastic.

10. The file system of claim 1, wherein the closure band has a width and wherein the label has a width, and wherein the width of the label is substantially larger than the width of the closure band.

11. The file system of claim 1, wherein the closure band has a width and wherein the label has a width, and wherein the width of the label is approximately the same as the width of the closure band.

12. The file system of claim 1, wherein the closure band has a width and wherein the label has a width, and wherein the width of the label is less than the width of the closure band.

13. The file system of claim 1, wherein the label is three-dimensional.

14. The file system of claim 1, wherein the label includes a support structure and a label structure.

15. The file system of claim 14, wherein the label structure is insertable into the support structure.

16. The file system of claim 15, wherein the support structure includes a window providing visual access to the label structure.

18. The file system of claim 1, wherein the label is flexible for permitting the label to bend around different sides of the file.

19. The file system of claim 1, wherein the label is replaceable on the closure band.

20. The file of claim 1, wherein the closure band is secured to the file by the attachment member.
